(19) United States
(12) Patent Application Publication
(10) Pub. No.: US 2015/0356054 A1
(43) Pub. Date: Dec. 10, 2015

(54) DATA PROCESSOR AND METHOD FOR DATA PROCESSING

(71) Applicants: Itzhak BARAK, Kadima (IL); Aviram AMIR, Petach-Tikva (IL); Eliezer BEN ZEEV, Bat Yam (IL)

(72) Inventors: Itzhak BARAK, KADIMA (IL); Aviram AMIR, PETACH-TIKVA (IL); Eliezer BEN ZEEV, BAT YAM (IL)

(73) Assignee: Freescale Semiconductor, Inc., Austin, TX (US)

(21) Appl. No.: 14/759,205

(22) PCT Filed: Jan. 10, 2013
(86) PCT No.: PCT/IB2013/050220

§ 371 Date: Jul. 3, 2015

(51) Int. Cl. G06F 15/80; G06F 9/30

(52) U.S. Cl. CPC G06F 15/8023; G06F 9/30098; G06F 9/30036

(57) ABSTRACT

A integrated circuit device has at least one instruction processing module arranged for executing vector data processing upon receipt of a respective one of a set of data processing instructions. The data processing instructions include at least one matrix processing instruction for processing elements of a matrix. The elements of rows of the matrix are stored in a set of register, and the instruction processing module comprising an accessing unit for accessing selected elements of the matrix, which selected elements are non-sequentially located according to a predetermined pattern across multiple registers of the set of registers, the accessing enabling respective processing lanes to write or read different registers. Advantageously elements in columns of a matrix can efficiently be processed.

### FIELD OF THE INVENTION

This invention relates to integrated circuit devices and methods for vector data processing. In the field of vector data processing an integrated circuit device may have at least one instruction processing module arranged for executing vector data processing upon receipt of a respective one of a set of data processing instructions. Such a single data processing instruction may operate on multiple data elements, also called SIMD.

### BACKGROUND OF THE INVENTION

The United States patent application document US 2010/0106944 describes a data processing apparatus and method for performing rearrangement operations. The data processing apparatus has a register data store with a plurality of registers, each register storing a plurality of data elements. Processing circuitry is responsive to control signals to perform processing operations on the data elements. An instruction decoder is responsive to at least one but no more than N rearrangement instructions, where N is an odd plural number, to generate control signals to control the processing circuitry to perform a rearrangement process. The process involves obtaining as source data elements the data elements stored in N registers of said register data store as identified by the at least one re-arrangement instruction; performing a rearrangement operation to rearrange the source data elements between a regular N-way interleaved order and a de-interleaved order in order to produce a sequence of result data elements; and outputting the sequence of result data elements for storing in the register data store. This provides a technique for performing N-way interleave and de-interleave operations.

However, the known system requires many instructions for some matrix processing operations.

### SUMMARY OF THE INVENTION

The present invention provides an integrated circuit device, and a method, as described in the accompanying claims.

Specific embodiments of the invention are set forth in the dependent claims. Aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings.

FIG. 1 shows an example of an instruction processing device,

FIG. 2 shows an example of vector data processing according to prior art,

FIG. 3 shows an example of a data processing device having matrix access,

FIG. 4a and FIG. 4b show examples of an instruction processing device for accessing different parts of a wide vector, and

FIG. 5a and FIG. 5b show examples of an instruction processing device for accessing columns of a matrix.

Elements in the figures are illustrated for simplicity and clarity and have not necessarily been drawn to scale. In the Figures, elements which correspond to elements already described may have the same reference numerals.

### DETAILED DESCRIPTION OF THE PREFERRED EMBODIMENTS

Examples of the present invention will now be described with reference to an example of an instruction processing architecture, such as a central processing unit (CPU) architecture. However, it will be appreciated that the present invention is not limited to the specific instruction processing architecture herein described with reference to the accompanying drawings, and may equally be applied to alternative architectures. For the illustrated example, an instruction processing architecture is provided comprising separate data and address registers. However, it is contemplated in some examples that separate address registers need not be provided, with data registers being used to provide address storage. Furthermore, for the illustrated examples, the instruction processing architecture is shown as comprising four data execution units. Some examples of the present invention may equally be implemented within an instruction processing architecture comprising any number of data execution units. Additionally, because the illustrated example embodiments of the present invention may, for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

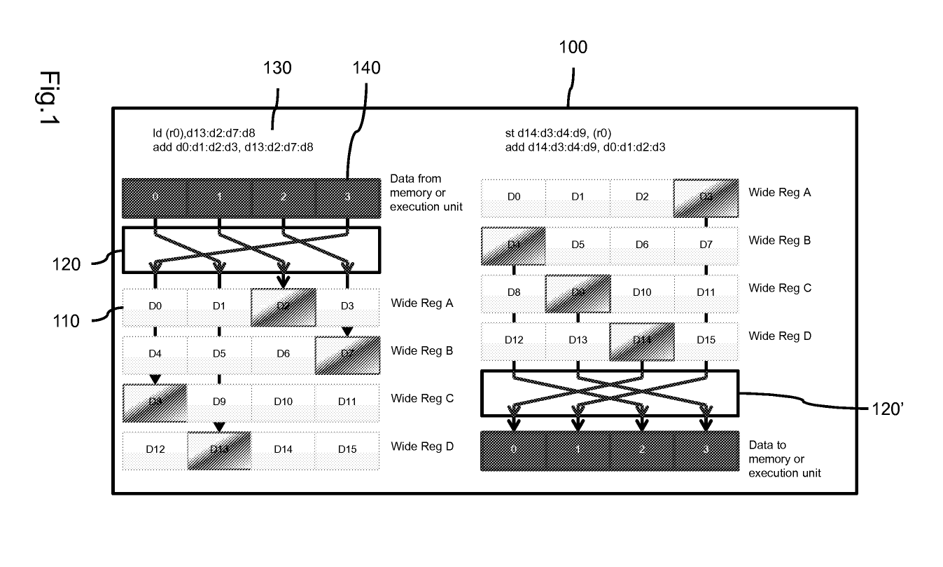

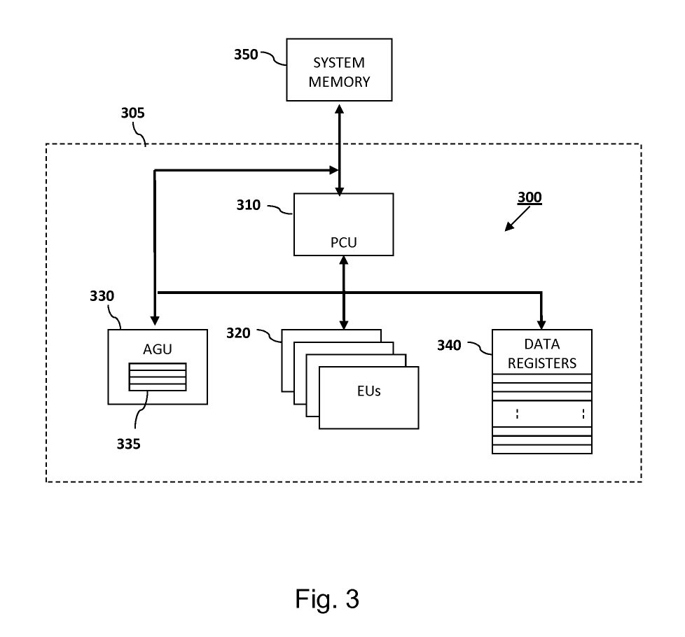

FIG. 1 shows an example of an instruction processing device. The Figure schematically shows an instruction processing module 100, which has a set of registers 110, depicted as WideReg A storing data elements D0,D1,D2,D3, WideReg B storing data elements D4,D5,D6,D7, WideReg C storing data elements D8,D9,D10,D11, and WideReg D storing data elements D12,D13,D12,D15. The module is shown to operate on data 140 from a memory or an execution unit, which data has 4 data elements 0,1,2,3. The execution unit as such, which is part of the instruction processing module, is not shown in FIG. 1, but is shown in FIG. 3. The instruction processing module is arranged for executing vector data processing upon receipt of a respective data processing instruction 130 of a set of data processing instructions.

The data processing instructions include at least one matrix processing instruction for processing elements of a matrix. The elements of rows of the matrix are sequentially stored in the set of registers 110. The matrix processing instruction triggers accessing matrix elements via an accessing unit. Thereto, the instruction processing module has an accessing unit 120,120′ for accessing selected elements of the matrix, which selected elements are non-sequentially stored according to a predetermined pattern across multiple registers of the set of registers.

In the example, the instruction processing module has a first accessing unit 120 that is shown to enable access to the data elements D2 in WideReg A, D7 in WideReg B, D8 in WideReg C and D13 in WideReg D for executing the data processing instruction 130. Furthermore, in the right halve of the Figure, further data processing is depicted in which the instruction processing module has a further accessing unit 120′ that is shown to enable access to the data elements D3 in WideReg A, D4 in WideReg B, D9 in WideReg C and D14 in WideReg D, which elements are added to generate data elements 0,1,2,3 to be outputted to memory or the execution unit.

By providing the access unit the system is provided with the ability to access a different wide register for each processing lane of the register, the accessing enabling respective processing lanes to write or read different registers. It is noted that the ability to access a different wide register for each processing lane may be implemented in the register file 110 in combination with a permutation unit as depicted in the Figures. The combined ability to access different wide registers and apply a suitable permutation is called access unit in this document. It is noted that multiple processing lanes, having respective execution units, may be provided to facilitate a single data processing instruction to operate on multiple data elements. The data processing device is further arranged to handle and execute a set of additional matrix instructions that support the new register addressing modes.

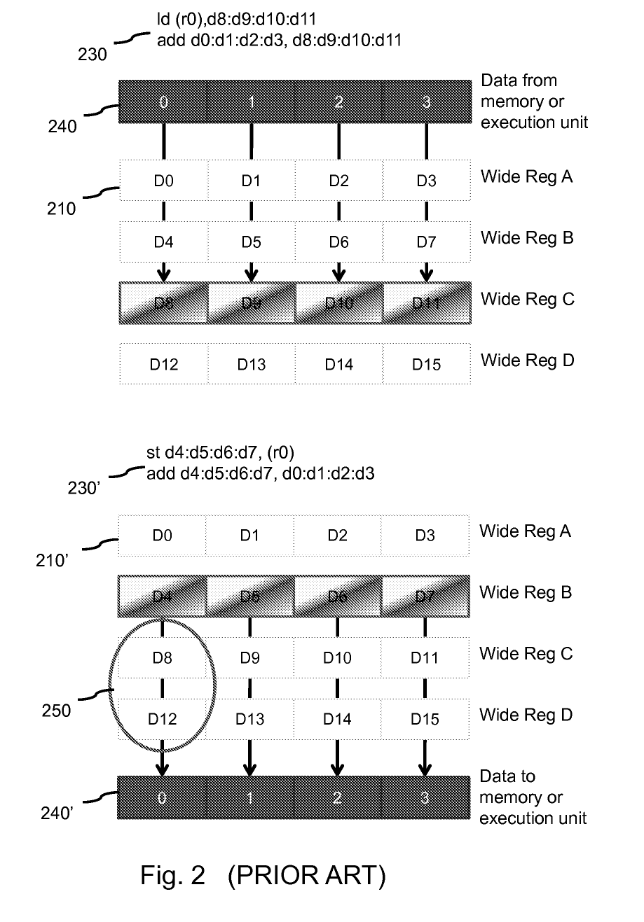

FIG. 2 shows an example of vector data processing according to prior art. Similar examples may be found in US2010/0106944, also cited in the introductory part. The Figure schematically shows two examples of the data processing having a set of registers 210, 210′, depicted as WideReg A storing data elements D0,D1,D2,D3, WideReg B storing data elements D4,D5,D6,D7, WideReg C storing data elements D8,D9,D10,D11, and WideReg D storing data elements D12,D13,D12,D15. The device is shown to operate on data 240 from external memory or an execution unit, which data has 4 data elements 0,1,2,3. The instruction processing module is arranged for executing vector data processing upon receipt of a respective data processing instruction 230,230′ of a set of data processing instructions.

The instructions 230 in the first example are “Id (r0),d8:d9:d10:d11” (i.e. load processor register r0 in the data elements D8,D9,D10,D11) or “add d0:d1:d2:d3, d8:d9:d10:d11” (i.e. add external data elements 0,1,2,3 to the data elements D8,D9,D10,D11).

The instructions 230′ in the second example are “st d4:d5:d6:d7, (r0)” (i.e. store to processor register r0 the data elements D4,D5,D6,D7) or “add d4:d5:d6:d7, d0:d1:d2:d3” (i.e. add the data elements D4,D5,D6,D7 to the data elements 0,1,2,3).

It is noted that in the prior art elements are accessed which are sequentially stored in the registers, e.g. in the second example of FIG. 2 elements D4,D5,D6,D7 from Wide Reg B. As indicated by an arrow highlighted by ellipse 250 each data element of a wide register is accessed while moving all elements from Wide Reg B to the output to memory or an execution unit.

The prior art access may be provided with a permutation unit between the operating register and the wide registers storing the vector data. However, although such permutation would enable rotation or swapping of data elements to or from a single wide register, such permutation unit would not enable access to data elements of different registers, e.g. for accessing a column of a stored matrix. Such access is only provided by said access units as described with reference to FIG. 1.

FIG. 3 shows an example of a data processing device having matrix access. In the Figure there is illustrated a simplified block diagram of an example of part of an instruction processing module 300 adapted in accordance with example embodiments of the present invention. For the illustrated example, the instruction processing module 300 forms a part of an integrated circuit device, illustrated generally at 305, and comprises at least one program control unit (PCU) 310, one or more execution modules 320, at least one address generation unit (AGU) 330 and a plurality of data registers, illustrated generally at 340. The PCU 310 is arranged to receive instructions to be executed by the instruction processing module 300, and to cause an execution of operations within the instruction processing module 300 in accordance with the received instructions. For example, the PCU 310 may receive an instruction, for example stored within an instruction buffer (not shown), where the received instruction requires one or more operations to be performed on one or more bits/bytes/words/etc. of data. A data ‘bit’ typically refers to a single unit of binary data comprising either a logic 0 or logic 1, whilst a ‘byte’ typically refers to a block of 8 bits. A data ‘Word’ may comprise one or more bytes of data, for example two bytes (16 bits) of data, depending upon the particular DSP architecture. Upon receipt of such an instruction, the PCU 310 generates and outputs one or more micro-instructions and/or control signals to the various other components within the instruction processing module 300, in order for the required operations to be performed. The AGU 330 is arranged to generate address values for accessing system memory (not shown), and may comprise one or more address registers as illustrated generally at 335. The data registers 340 provide storage for data fetched from system memory 350, and on which one or more operation(s) is/are to be performed, and from which data may be written to system memory. The execution modules 320 are arranged to perform operations on data (either provided directly thereto or stored within the data registers 340) in accordance with micro-instructions and control signals received from the PCU 310. As such, the execution modules 320 may comprise arithmetic logic units (ALUs), etc.

It is noted that load, store and add are commonly used matrix instructions, but the set of instructions may comprises any further instruction, such as MUL, MAC, SUBTR, LOGIC, etc. Such instructions are used for multiplication, accumulation, subtraction, and logical functions. For example, a specific instruction may transfer data, multiply those data and execute accumulation. Such an instruction may specify multiple data transfers and multiplication operations, and/or subtraction and addition circuit operations.

It is noted that, in the processing module, the access to the data registers has been enhanced by providing said access units (not shown in FIG. 3, but discussed with reference to FIG. 1) for enabling accessing selected elements of a matrix, which selected elements are non-sequentially stored according to a predetermined pattern across multiple registers of the data registers 340. The new instructions are actually implemented in the AGU for load/store moving data from the memory system to the data registers.

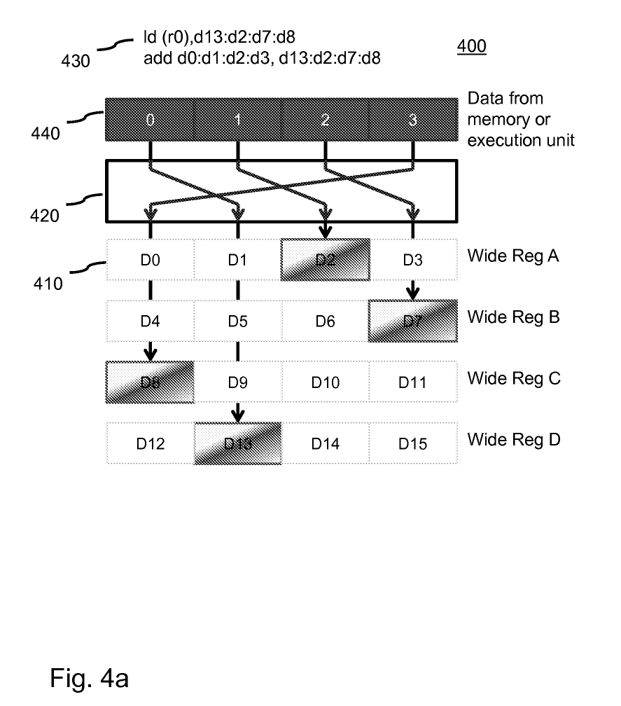

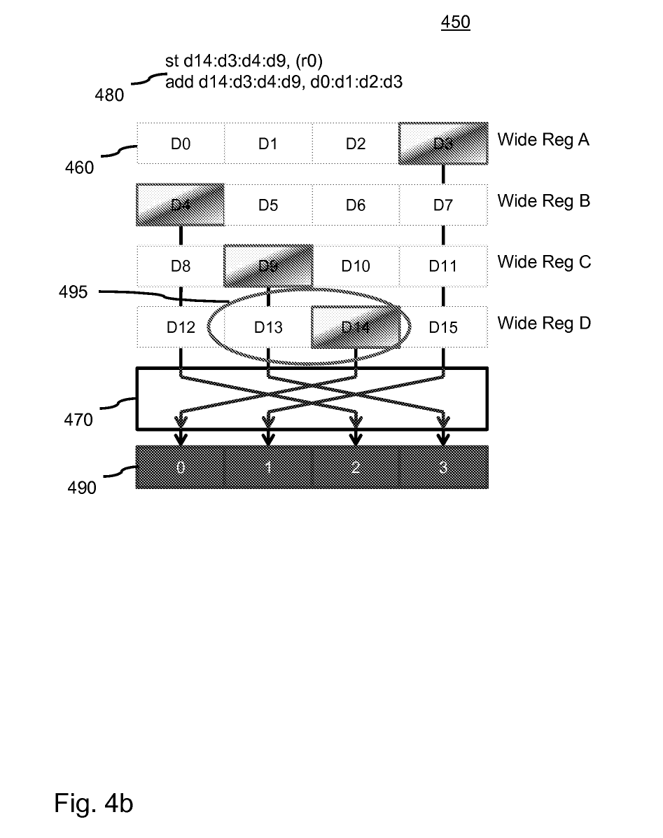

FIG. 4a and FIG. 4b show examples of an instruction processing device for accessing different parts of a wide vector. In the example, added access units 420,470 enable an extended vector processing, wherein selected elements of the vector to be processed can be part of a different wide vector stored in multiple wide registers.

The FIG. 4a schematically shows an instruction processing module 400, which has a set of wide registers 410, depicted as WideReg A storing data elements D0,D1,D2,D3, WideReg B storing data elements D4,D5,D6,D7, WideReg C storing data elements D8,D9,D10,D11, and WideReg D storing data elements D12,D13,D12,D15. The module is shown to operate on data from a memory or an execution unit via a data bus or an operational register 440, which data has 4 data elements 0,1,2,3. The execution unit as such, which is part of the instruction processing module, is not shown in FIG. 4, but is shown in FIG. 3. The instruction processing module is arranged for executing vector data processing upon receipt of a respective data processing instruction 430 of a set of data processing instructions.

The wide vector may constitute a matrix. The elements of rows of the matrix are sequentially stored in the set of registers 410. The matrix processing instruction triggers accessing matrix elements via an accessing unit. Thereto, the instruction processing module has an accessing unit 420 for accessing selected elements of the matrix, which selected elements are non-sequentially stored according to a predetermined pattern across multiple registers of the set of registers.

For enabling the non sequential access the access unit 420 is coupled to said multiple registers 410 and includes a permutation function, as indicated by arrows in the unit as depicted in FIG. 4, for rearranging the accessed data elements in the operational register. The permutation that is used is a barrel shifter permute, which is, as such, a re-use of a pre-existing permute unit that helps loading aligned and unaligned data from memory into the registers.

Combining the permute function with the new mechanism that writes (or reads) each part of the data bus or respective lane into (or from) a different register, enables the new register ordering that in turn enables a fast matrix element access, in particular column access. It is noted that a matrix to be so processed may be two-dimensional and have a row size of n and a column size of m elements. Note that n and m are integers of any value and n may differ from m. In practice n and m will usually be equal. The size of the matrix row may be 2ⁿ, where 2ⁿ is two to the power n. Also, the size of the matrix column may be 2ⁿ. In practice, n may be 2, 3 or 4 and the matrix is a two-dimensional matrix of a matrix size 4×4, 8×8 or 16×16 respectively. Furthermore, the matrix processing instruction may comprise an indication of the matrix row and/or column size.

In the example, the instruction processing module has an accessing unit 420 that is shown to enable access to the data elements D2 in WideReg A, D7 in WideReg B, D8 in WideReg C and D13 in WideReg D for executing the data processing instruction 130.

The FIG. 4b shows a further data processing in which the instruction processing module has a further accessing unit 470 that is shown to enable access to the data elements D3 in WideReg A, D4 in WideReg B, D9 in WideReg C and D14 in WideReg D, which elements are added to generate output data elements 0,1,2,3 to be outputted to memory or the execution unit.

By providing the access unit the system is provided with the ability to access a different wide register for each processing lane of the register. For example, D9 from wide register B is accessed to provide output data element 2, whereas element D14 from wide register D is accessed to provide output data element 0. In the new load operation, a single load loads a single row but each column element of the row ends up in a different wide register. Two such operations locate two elements of the same column side by side in the same wide register, as marked by an ellipse 495, and thus enable wide access to them by a later operation, for example either a store operation or an ALU operation such as ADD.

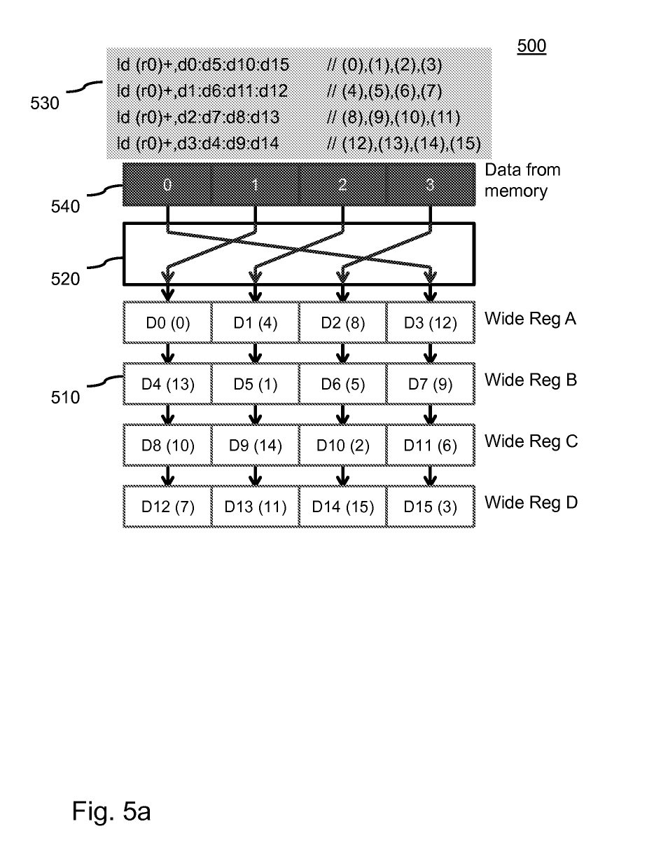

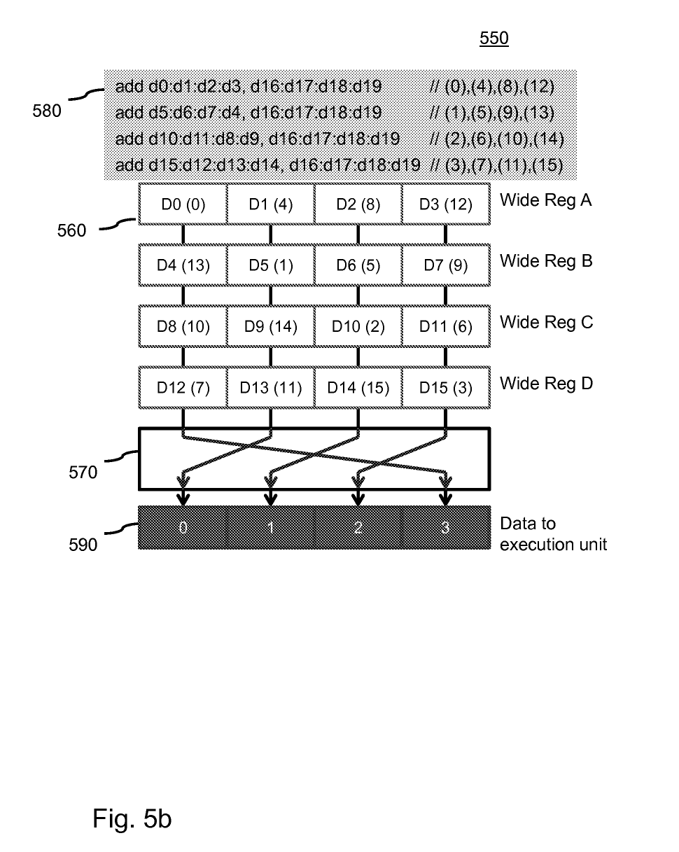

FIG. 5a and FIG. 5b show examples of an instruction processing device for accessing columns of a matrix. The registers 510 have data locations D0 . . . D15 similar to FIG. 4. In the example, the added access units 520,570 enable matrix processing, wherein elements of the matrix to be processed are retrieved from, or outputted to, memory in which the elements of the rows are sequentially stored. In particular, FIG. 5a shows a load from memory into the registers 510 using the access unit 520 for permutation and the ability to write to different wide registers on each processing lane. What can be seen is that even though the matrix is read from memory in row by row order (first instruction load the first row, etc.), at the end of the load each wide register holds a column of the input matrix, in which the data is rotated. FIG. 5b shows that an execution unit can read each wide register using the access unit 570 to correct by permutation said rotation and hence accesses a column of the original matrix.

The modules are shown to operate on data 540,590 from/to a memory or an execution unit, which data has 4 data elements 0,1,2,3. The execution unit as such, which is part of the instruction processing module, is not shown in FIG. 5, but is shown in FIG. 3. The instruction processing module is arranged for executing vector data processing upon receipt of a respective data processing instruction 530,580 of a set of data processing instructions.

The FIG. 5a schematically shows an instruction processing module 500, which has a set of registers 510. In the Figure, in the register, the elements of the matrix are indicated to be stored in the respective wide register locations by indices (0) . . . (15), of which the elements (0),(4), (8), (12) constitute the first column of the matrix, etc, as loaded from memory by 4 consecutive load instructions 530:
Id (r0)+,d0:d5:d10:d15 //loading elements (0),(1),(2),(3)
Id (r0)+,d1:d6:d11:d12 //loading elements (4),(5),(6),(7)
Id (r0)+,d2:d7:d8:d13 //loading elements (8),(9),(10),(11)
Id (r0)+,d3:d4:d9:d14 //loading elements (12),(13),(14),(15)

It is noted that the access unit 520 loads the respective column values in the respective locations of the wide registers as indicated by subsequent permutations while accessing the respective locations according to a predetermined pattern. The arrows as shown in the Figure in unit 520 and below are an example of such permutation. Writing to different wide registers in different processing lanes is used in FIG. 5a to generate this load pattern.

The FIG. 5b schematically shows an instruction processing module 550, which has a set of registers 560. In the Figure, in the register, the elements of the matrix are indicated to be previously stored in the respective wide register locations by indices (0) . . . (15), of which the elements (0), (4), (8), (12) constitute the first column of the matrix, etc. The contents of the columns are added and outputted to memory by 4 consecutive add instructions 580:
add d0:d1:d2:d3, d16:d17:d18:d19 //adding 1^{st} column (0),(4),(8),(12)
add d5:d6:d7:d4, d16:d17:d18:d19 //adding 2^{nd} column (1),(5),(9),(13)
add d10:d11:d8:d9, d16:d17:d18:d19 //adding 3^{rd} column (2),(6),(10),(14)
add d15:d12:d13:d14, d16:d17:d18:d19 //adding 4^{th} column (3),(7),(11),(15)

It is noted that the access unit 570 retrieves the respective column values from the respective locations of the wide registers as indicated by subsequent permutations while accessing the respective locations according to a predetermined pattern. The arrows as shown in the Figure in unit 570 and below are an example of such permutation.

The subsequent execution of the processing as shown in FIGS. 5a and 5b is a usage example of matrix processing, in which a matrix of a size 4×4 is first loaded from memory, and subsequently column values are added.

In the following an example is provided of a software program using the matrix processing instructions for execution on a processor comprising the instruction processing module as described above, based on a matrix size of 8×8. Practical values for the matrix size may be 2ⁿ, e.g. n being 2,3 or 4, and the matrix size correspondingly being 4×4, 8×8, or 16×16. Other matrix sizes may be implemented also where required and efficient for certain applications.

The instructions comprise load (LD2), store (ST2) and add (ADDA) instructions. The instructions are shown to have an indication of the matrix row and/or column size by the parameters as indicated after the respective instruction code. Also, in the example, the matrix processing instructions include an indication of the predetermined pattern for accessing the elements by the enumeration of the respective elements. The program is an example of a reversal of values in a matrix, also called matrix transpose:

; code using matrix instructions
; 16 cycles for permutation (reordering) of 128 complex values
loopstart0
[ ;01

| | |
|---|---|
| ST2.SRS.16F d0:d9:d18:d27:d36:d45:d54:d63,(r1)+R18 | ; save |
| LD2.16F (r9)+R16,d0:d9:d18:d27:d36:d45:d54:d63 | ; load |

| | |
|---|---|
| ADDA.LIN R19,r1,R25 | ; ADDA.LIN #1*N*4/8,r1,r25 |

]

[ ;05

| | |
|---|---|
| ST2.SRS.16F d4:d13:d22:d31:d32:d41:d50:d59,(R25)+R16 | ; save |
| LD2.16F (r9)+R16,d4:d13:d22:d31:d32:d41:d50:d59 | ; load |

ADDA.LIN #(16*2),R17,R17
]

[ ;03

| | |
|---|---|
| ST2.SRS.16F d2:d11:d20:d29:d38:d47:d48:d57,(R25)+R16 | ; save |
| LD2.16F (r9)+R16,d2:d11:d20:d29:d38:d47:d48:d57 | ; load |

]

[ ;07

| | |
|---|---|
| ST2.SRS.16F d6:d15:d16:d25:d34:d43:d52:d61,(R25)+R16 | ; save |
| LD2.16F (r9)+R16,d6:d15:d16:d25:d34:d43:d52:d61 | ; load |

]

[ ;02

| | |
|---|---|
| ST2.SRS.16F d1:d10:d19:d28:d37:d46:d55:d56,(R25)+R16 | ; save |
| LD2.16F (r9)+R16,d1:d10:d19:d28:d37:d46:d55:d56 | ; load |

]

[ ;06

| | |
|---|---|
| ST2.SRS.16F d5:d14:d23:d24:d33:d42:d51:d60,(R25)+R16 | ; save |
| LD2.16F (r9)+R16,d5:d14:d23:d24:d33:d42:d51:d60 | ; load |

]

[ ;04

| | |
|---|---|
| ST2.SRS.16F d3:d12:d21:d30:d39:d40:d49:d58,(R25)+R16 | ; save |
| LD2.16F (r9)+R16,d3:d12:d21:d30:d39:d40:d49:d58 | ; load |

]

[ ;08

| | |
|---|---|
| ST2.SRS.16F d7:d8:d17:d26:d35:d44:d53:d62,(R25)+R16 | ; save |
| LD2.16F (r9),d7:d8:d17:d26:d35:d44:d53:d62 | ; load |

ADDA.LIN #0,R17,r9
]

[ ;09

| | |
|---|---|
| ST2.SRS.16F d0:d1:d2:d3:d4:d5:d6:d7,(r1)+R18 | ; save |
| LD2.16F (r9)+R16,d0:d1:d2:d3:d4:d5:d6:d7 | ; load |

| | |
|---|---|
| ADDA.LIN R19,r1,R25 | ; ADDA.LIN #1*N*4/8,r1,r25 |

]

[ ;13

| | |
|---|---|
| ST2.SRS.16F d36:d37:d38:d39:d32:d33:d34:d35,(R25)+R16 | ; save |
| LD2.16F (r9)+R16,d36:d37:d38:d39:d32:d33:d34:d35 | ; load |

ADDA.LIN #(16*2),R17,R17
]

[ ;11

| | |
|---|---|
| ST2.SRS.16F d18:d19:d20:d21:d22:d23:d16:d17,(R25)+R16 | ; save |
| LD2.16F (r9)+R16,d18:d19:d20:d21:d22:d23:d16:d17 | ; load |

]

[ ;15

| | |
|---|---|
| ST2.SRS.16F d54:d55:d48:d49:d50:d51:d52:d53,(R25)+R16 | ; save |
| LD2.16F (r9)+R16,d54:d55:d48:d49:d50:d51:d52:d53 | ; load |

]

[ ;10

| | |
|---|---|
| ST2.SRS.16F d9:d10:d11:d12:d13:d14:d15:d8,(R25)+R16 | ; save |
| LD2.16F (r9)+R16,d9:d10:d11:d12:d13:d14:d15:d8 | ; load |

]

[ ;14

| | |
|---|---|
| ST2.SRS.16F d45:d46:d47:d40:d41:d42:d43:d44,(R25)+R16 | ; save |
| LD2.16F (r9)+R16,d45:d46:d47:d40:d41:d42:d43:d44 | ; load |

]

[ ;12

| | |
|---|---|
| ST2.SRS.16F d27:d28:d29:d30:d31:d24:d25:d26,(R25)+R16 | ; save |
| LD2.16F (r9)+R16,d27:d28:d29:d30:d31:d24:d25:d26 | ; load |

]

[ ;16

| | |
|---|---|
| ST2.SRS.16F d63:d56:d57:d58:d59:d60:d61:d62,(R25)+R16 | ; save |
| LD2.16F (r9),d63:d56:d57:d58:d59:d60:d61:d62 | ; load |

ADDA.LIN #0,R17,r9
]

loopend0

For such transpose function any “traditional” implementation of transpose of a big 2D array that cannot fit into a single row of the target processor, requires read or write the array with no vectorization, since a single element of the array has to be accessed. No other elements that can be accessed at the same time. Since load/store accesses are a limiting factor in every processor architecture, which normally can perform only one or two transactions every cycle, regardless of the transaction width, accessing an array without vectorization will cost N time cycles, when N is the length of the vector. In the example N is 8.

The function executed by the above program using the enhanced matrix processing instructions requires only 16 cycles. When performing the same function using traditional code (not using vectorization) 96 cycles for permutation of 128 complex values would be required:

loopstart0

[
move.2l (r4)+n1,d0:d1
move.2l (r5)+n1,d2:d3
]
[
move.l d0,(r0)+n0
move.l d1,(r1)+n0
]
[
move.l d2,(r0)+n0
move.l d3,(r1)+n0
]

loopend0

The traditional code without the new instructions needs to break all the loads or vectorized loads (LD2.16F) into 8 separate loads (LD2.2F), and using linear register order for the stores (ST2.16F or ST2.SRS.16F). It is easy to see that number of cycles increases significantly by using traditional code.

In a further practical application the new matrix instructions may be used for FFT. A special register order may be provided for use in such routine. In addition to the above transpose routine, it uses special FFT reverse-carry addressing. The new FFT implementation using the enhanced matrix instructions enables FFT reverse carry reordering, by wide load and store across the matrix (8 words in parallel), accelerating this phase by factor of 8.

In summary, the enhancement resides in that the instruction module can access different wide registers at every respective different processing lane. The additional circuitry does not require a wider data path, while it provides wide access to columns of 2D complex non-serial data structures

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be a type of connection suitable to transfer signals from or to the respective nodes, units or devices, for example via intermediate devices. Accordingly, unless implied or stated otherwise the connections may for example be direct connections or indirect connections.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Although the invention has been described with respect to specific conductivity types or polarity of potentials, skilled artisans appreciated that conductivity types and polarities of potentials may be reversed.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device.

Furthermore, the units and circuits may be suitably combined in one or more semiconductor devices.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An integrated circuit device comprising:
at least one instruction processing module arranged for executing vector data processing upon receipt of a respective one of a set of data processing instructions, the data processing instructions comprising at least one matrix processing instruction for processing elements of a matrix, the elements of rows of the matrix being stored in a set of registers, and the instruction processing module comprising an accessing unit for accessing selected elements of the matrix, which selected elements are non-sequentially located according to a predetermined pattern across multiple registers of the set of registers, the accessing enabling respective processing lanes to write or read different registers.

2. Device as claimed in claim 1, wherein the predetermined pattern determines accessing the selected elements according to a column of the matrix.

3. Device as claimed in claim 1, wherein the matrix is a two-dimensional matrix.

4. Device as claimed in claim 1, wherein the matrix processing instruction comprises an indication of the predetermined pattern.

5. Device according to claim 1, wherein the size of the matrix row is 2ⁿ, wherein n is an integer and 2ⁿ is two to the power n.

6. Device as claimed in claim 5, wherein the size of the matrix column is 2ⁿ.

7. Device as claimed in claim 5, wherein n is 2, 3 or 4 and the matrix is a two-dimensional matrix of a matrix size 4×4, 8×8 or 16×16 respectively.

8. Device according to claim 1, wherein the matrix processing instruction comprises an indication of the matrix row and/or column size.

9. Device as claimed in claim 1, wherein the at least one matrix processing instruction comprises a load instruction according to the predetermined pattern, a store instruction according to the predetermined pattern, or an add instruction according to the predetermined pattern.

10. Device as claimed in claim 1, wherein the at least one instruction processing module comprises multiple instruction processing modules.

11. Method of instruction processing arranged for executing vector data processing upon receipt of a respective one of a set of data processing instructions, the data processing instructions comprising at least one matrix processing instruction for processing elements of a matrix, the elements of rows of the matrix being stored in a set of registers, and the instruction processing comprising accessing selected elements of the matrix, which selected elements are non-sequentially located according to a predetermined pattern across multiple registers of the set of registers.

12. Method as claimed in claim 11, wherein the predetermined pattern determines accessing the selected elements according to a column of the matrix.

13. Method as claimed in claim 11, wherein the matrix is a two-dimensional matrix.

14. Method as claimed in claim 11, wherein the matrix processing instruction comprises an indication of the predetermined pattern.

15. Method according to claim 11, wherein the size of the matrix row is 2ⁿ, wherein n is an integer and 2ⁿ is two to the power n.

16. Method as claimed in claim 15, wherein the size of the matrix column is 2ⁿ.

17. Method as claimed in claim 15, wherein n is 2,3 or 4 and the matrix is a two-dimensional matrix of a matrix size 4×4, 8×8 or 16×16 respectively.

18. Method according to claim 11, wherein the matrix processing instruction comprises an indication of the matrix row and/or column size.

19. Method as claimed in claim 11, wherein the at least one matrix processing instruction comprises one of a group consisting of: a load instruction according to the predetermined pattern, a store instruction according to the predetermined pattern, and an add instruction according to the predetermined pattern.

20. A tangible computer program product comprising instructions for causing a processor system to perform vector data processing upon receipt of a respective one of a set of data processing instructions, the data processing instructions comprising at least one matrix processing instruction for processing elements of a matrix, the elements of rows of the matrix being stored in a set of registers, and the instruction processing comprising accessing selected elements of the matrix, which selected elements are non-sequentially located according to a predetermined pattern across multiple registers of the set of registers.
